(19) United States
(12) Patent Application Publication
(10) Pub. No.: US 2019/0385258 A1
(43) Pub. Date: Dec. 19, 2019

(54) COMPLIANCE ASSESSMENT AND IMPROVEMENT SYSTEM AND METHODS

(71) Applicants: The Major Group Inc., Eden Prairie, MN (US); Software Performance Group Inc., Fredericksburg, VA (US)

(72) Inventor: Chad Cloud, Burke, VA (US)

(21) Appl. No.: 16/534,994

(22) Filed: Aug. 7, 2019

Related U.S. Application Data
(63) Continuation of application No. 14/287,617, filed on May 27, 2014, now abandoned.
(60) Provisional application No. 61/827,183, filed on May 24, 2013.

(51) Int. Cl. G06Q 50/20; G06Q 10/00

(52) U.S. Cl. CPC G06Q 50/2057; G06Q 10/00

(57) ABSTRACT

A method of assisting a person, entity, or user in achieving a target, which includes a new position, status, certification, or identifiable goal. The method includes three independent functions, wherein an initial common operations, attribute and training presentation function, and alternative target presentation function are performed. The invention includes processes that generate a single value assessment score of a user, inform the user of attributes associated with the target, provide training programs related to important attributes of the target, and provide the user with suggestions of similar targets based on the attributes and response levels of the user.

This application is a continuation of, and claims the benefit of, copending U.S. patent application Ser. No. 14/287,617, filed May 27, 2014, which claims the benefit of U.S. Provisional Application No. 61/827,183, filed May 24, 2013, each of which is hereby incorporated by reference in its entirety herein.

### SUMMARY OF THE INVENTION

The invention addresses the general problem of assisting a person or entity in achieving a new position, status, or certification. One way to do that is to determine appropriate ameliorative steps that are required to bridge the gap between the levels of achievement a given person or entity currently has and the levels of achievement that are required of a person or entity that is compliant with externally specified requirements for the desired position, status, or certification. Achievement is measured by the levels of performance of the person or entity with respect to each of several attributes that are important for the desired position, status, or certification. A prime example is the need for a tool to assist persons who want to apply for a new job. They would benefit from assistance in determining how close their own attribute achievement levels are to the attribute achievement levels that are required of persons who occupy that job. Another interest is to provide job applicants with access to training resources that might help them close the gap between their achievement levels and the required achievement levels on each attribute that is important for the job they originally sought. Another interest is to give users suggestions for jobs similar to the one they originally sought but for which their current attribute achievement levels may be sufficient or more nearly sufficient.

The invention includes the following processes that:
(1) generate a single value overall Assessment Score of the person or entity;
(2) inform users or entities on the important Attributes associated with the new position, status, or certification they want to apply for, the standard levels of achievement in those Attributes, and their own achievement levels in those Attributes;
(3) provide training programs that are geared to the important Attributes of the new position, status, or certification sought by the users or entities; and
(4) provide suggestions for similar new positions, status, or certifications the user or entity may consider given their current achievement levels.

The process may reside on a general purpose computer or in a specialized machine designed specifically for the purpose of enabling the process. For either case, the invention is referred to as the “Tool.”

A new position, career, status, or certification, or similarly identifiable goals are referred to as the Target, and any collection of Targets as a Functional Regime. The structure of the Tool is independent of the Functional Regime.

The Tool has access to a Database that contains at least the following elements associated with each of one or more available Functional Regimes:
Attributes which may be grouped according to Qualities. Optionally the Database may include the Importance of each Attribute and/or Quality, relative to all the other Attributes and/or Qualities within a given Functional Regime;
a collection of one or more Queries associated with each Attribute, where each Query has a set of possible graded responses ordered from 0 to r, and where r may be different for each Query; and
a collection of Attribute Standards that include the Standard Level to each Query in the range of 0 to r.

The tool also has access to an Improvement Programs database that include:
improvement Methods that are linked to each Query; and
optional Subscriber Organizations that provide each of the Improvement Methods.

The Tool includes a series of operations. The outputs of the operations are defined by the inputs from the previous operations in the series and by accessing the Database, the Improvement Programs database, and user inputs. The operations performed by the Tool depend on which Function the Tool is asked to perform.

These and further and other objects and features of the invention are apparent in the disclosure, which includes the above and ongoing written specification, with the drawings.

### BRIEF DESCRIPTION OF THE DRAWINGS

FIG. 1 is a diagram of an overall gap assessment function

FIG. 2 is a diagram of an attribute and training presentation function

FIG. 3 is a diagram of an alternative target presentation function

### DETAILED DESCRIPTION

The Tool 10 has a database 12 which stores Functional Regimes 14, Targets 15, Attributes 16, Queries 17 and Attribute Standards 18.

### Initial Common Operations

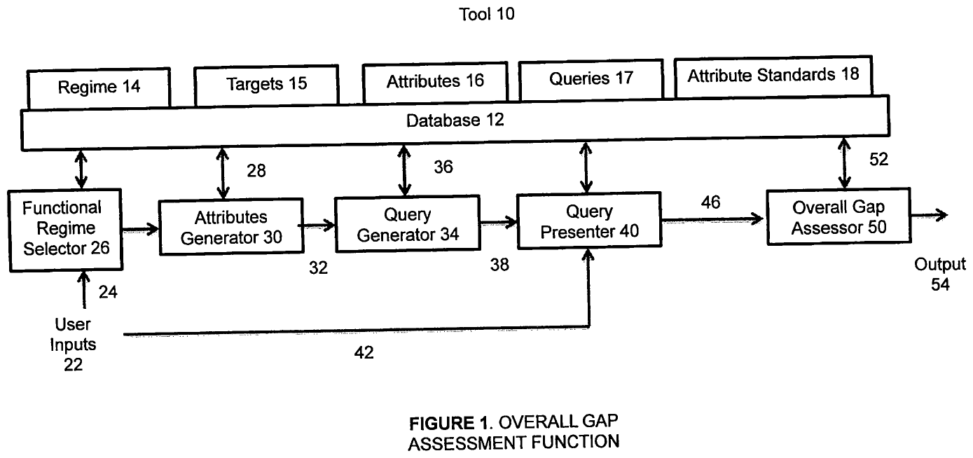

The Initial Operations are common to all Functions in FIGS. 1-3.

A user 22 of the Tool 10 first inputs 24 a proposed Functional Regime and a specific Target in Functional Regime Selector 26. The Tool retrieves 28 the Attributes associated with the proposed Target and passes 32 those Attributes to the Query Generator 34.

The Query Generator 34 accepts 36 the Queries 17 associated with each Attribute 16, and if Importance Data is available for that Attribute the Query Generator selects only those N Queries that rank in the top N values of Importance where N is between 0 and the total number of Queries available for that Attribute. The selected Queries are passed on to the Query Presenter 40.

The Query Presenter 40 thereafter accepts 38 all the Queries from the Query Generator 34 and presents 42 the Queries to the user of the Tool. The Query Generator collects the Response Levels to each Query and passes 46 the Response Levels to the next step.

### Overall Gap Assessment Function

As shown in FIG. 1, after performing the Initial Common Operations, the Overall Gap Assessment Function performs Operation GA4:

In GA4, the Overall Gap Assessor 50 accepts 46 the Response Levels and accesses 52 the Attributes Database 12 for the Attribute Standard Levels 18 associated with each Attribute 16. Then the Overall Gap Assessor 50 automatically computes, for each Attribute, the difference, or “Gap,” between the user's Response Levels and the Standard Levels. The Overall Gap Assessor combines each Gap with the Importance Data for the associated Attribute (if available) and computes a single value 54 that represents the Overall Assessment of Compliance which is presented to the user. One example of this computation is:

(i) computing the numerical difference between the user's Response Levels and the Standard Levels for the results of each Query;
(ii) multiplying the differences by the Importance associated with the Query;
(iii) computing the sum of all the products;
(iv) dividing by the sum of all the Importance values; and
(v) normalizing final value.

Although this is one example, other computational schemes may be used to compute the Overall Gap.

### Attribute and Training Presentation Function

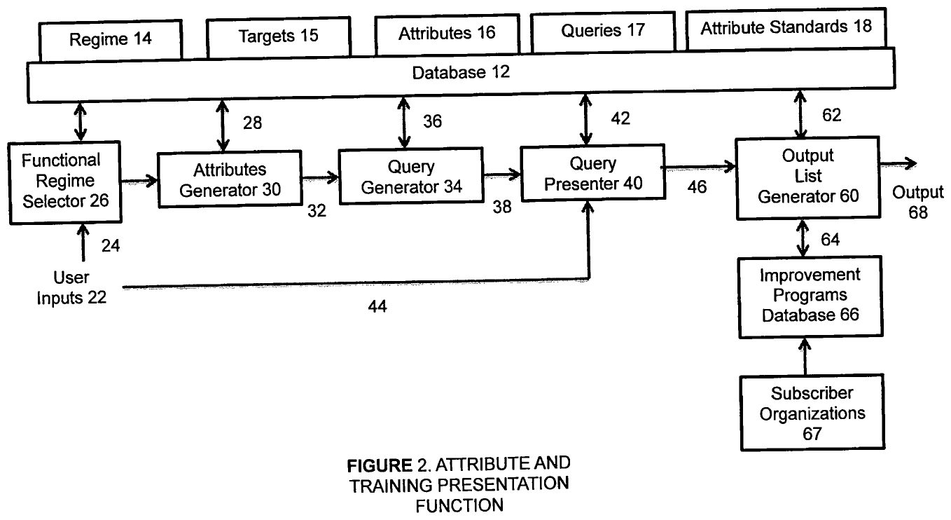

As shown in FIG. 2, after performing the Initial Common Operations, the Attribute and Training Presentation Function performs Operation AT4:

In AT4, the Output List Generator 60 accepts 46 the user's Response Levels and accesses 62, 64 two databases:
(i) the Database 12 to obtain the Attribute Standard Levels 18 and Importance Data associated with each Attribute (if available), and
(ii) the Improvement Programs Database 66 to obtain the Improvement Programs from Subscriber Organizations 67 associated with each Attribute.

The Output List Generator 60 then outputs 68 a list that includes three elements for each Attribute: the user's Response Level (Normalized if needed) for each Attribute, the Standard Levels (Normalized if needed) for each Attribute, and Improvement Programs associated with each Attribute.

### Alternative Target Presentation Function

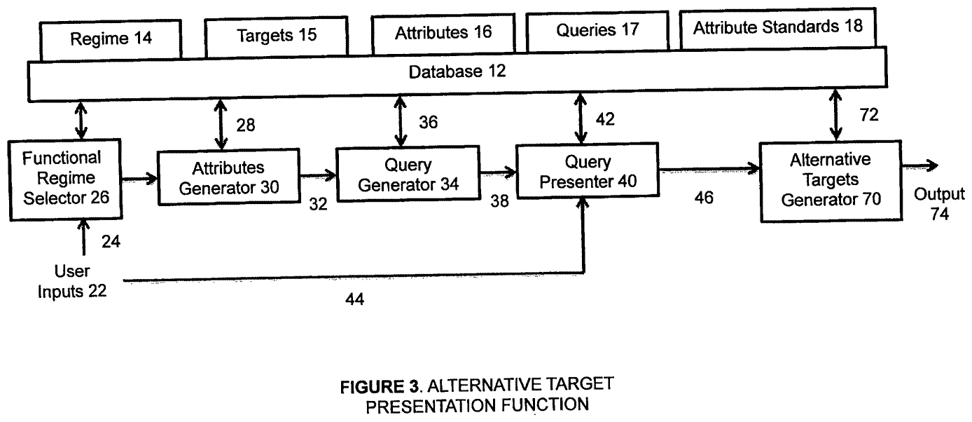

As shown in FIG. 3, after performing the Initial Common Operations the Alternative Target Presentation Function performs Operation AJ4:

In AJ4, the Alternative Targets Generator 70 accepts 46 the user's Response Levels 46 and accesses the Database 12 for the Attribute Standard Levels 18 associated with each Attribute 16. The Alternative Targets Generator 70 then searches 72 the Database 12 for Targets 15 across all Functional Regimes 14 or in a user-specified and selected 26 subset of Functional Regimes, for Targets 15 for which the user's current response level for each associated Attribute 16 would be a closer fit to the Standard Levels 18 for each associated Attribute 16. The Targets 15 found as a result of the search are presented 74 to the user.

### EXAMPLE

In one example, the Functional Regime 14 is chosen from a list of possible careers or job functions and the Targets 15 would be general careers (such as “Programmer”) or specific jobs (such as “Lead Programmer at Company X”). Here Attributes 16 are typically grouped into Qualities such as knowledge, abilities, education level, experience, certifications, and other job-defining qualities. The Attributes 16 are drawn from these Qualities. The Improvement Programs 66 include training programs offered by the Subscriber Organizations 67.

In another example, the Tool's use may be limited to a single Functional Regime, for example, all communications electronics technician jobs. In this case the Tool may be implemented such that the Functional Regime Selector acts merely to accept the Target from the user.

In another example, the importance Data may be absent, and all Queries are treated of equal importance. In this case the Tool need not do any calculations involving relative importance of Queries associated with Attributes.

These and other features and objects of the invention are described with reference to the drawings.

While the invention has been described with reference to specific embodiments, modifications and variations of the invention may be constructed without departing from the scope of the invention, which is defined in the following claims.

1-15. (canceled)

16. A method of assisting a user (i.e., a person or entity) in achieving a new position, status, certification, or identifiable goal, the method providing a single value overall user assessment score comprising the steps of:
providing an assessment and improvement tool comprising:
a database comprising functional regimes, targets, attributes, queries, graded responses, attribute standards, and standard levels, wherein:
a target is a new position, status, certifications, or identifiable goal;
a functional regime has one or more associated targets;
a target has one or more associated attributes;
an attribute has associated:
attribute standards comprising one or more standard levels which represent required achievement levels related to the attribute; and
one or more queries comprising one or more graded responses, wherein:
a user input received in response to a query related to the attribute is a response level comprised by the one or more graded responses and represents a user achievement level related to the attribute; and
a difference between the response level and a corresponding standard level of the attribute standards associated with the attribute assesses a deficiency, meeting or exceeding in the user achieved level when assessed against a required level of achievement associated with the attribute;
a functional regime selector operation;
an attributes generator operation;
a query generator operation;
a query presenter operation; and
an overall gap assessor operation;
accepting by the functional regime selector from a user a user input of a functional regime and a proposed target, wherein the functional regime selector inputs the proposed target into the attribute generator;
retrieving by the attribute generator from the database one or more attributes associated with the proposed target, wherein the attribute generator inputs the one or more retrieved attributes into the query generator;
retrieving by the query generator from the database one or more queries which comprise one or more graded responses and are associated with the attributes, wherein the query generator inputs at least one of the one or more retrieved queries into the query presenter;
presenting by the query presenter to the user the at least one of the one or more retrieved queries (thereby also referable to as presented queries);
receiving by the query presenter from the user one or more user inputs in response to the presented queries which are one or more response levels associated with the one or more graded responses associated with the presented queries, wherein the query presenter inputs the one or more response levels into the overall gap assessor;
retrieving by the overall gap assessor from the database one or more standard levels associated with the attributes associated with the presented queries;
determining a single value overall user assessment score at least in part by determining the differences between one or more of the one or more response levels and one or more of the one or more retrieved standard levels; and
presenting to the user the single value overall user assessment score, wherein the single value overall user assessment score is usable to evaluate the proposed target, thereby assisting the user in achieving a new position, status, certification, or identifiable goal.

17. The method of claim 16, wherein the database further comprises importance data and an attribute further has associated importance data indicating an importance of each attribute relative to other attributes associated with a target associated with a functional regime, the method further comprising retrieving by the query generator importance data associated with the one or more retrieved attributes from the database, wherein the one or more retrieved queries are selected for retrieval based, at least in part, on the retrieved importance data.

18. The method of claim 17, wherein the step of determining a single value overall user assessment score comprises the steps of:
computing for each of the one or more retrieved attributes a difference between the one or more response levels of the user and the corresponding one or more retrieved standard levels, wherein a negative difference indicates a user deficiency in attribute achievement and a positive number indicates a user exceeding in attribute achievement;
combining each of the differences with the retrieved importance data for the associated one or more retrieved attributes; and
computing a single value overall user assessment score from the each of the combined differences and retrieved importance data, wherein the single value overall user assessment score represents an overall assessment of the user's attribute achievement levels in the one or more attributes associated with the proposed target versus the required achievement levels (i.e. compliance) in the one or more attributes associated with the proposed target, and a negative single value overall user assessment score indicates a user deficiency in overall attribute achievement for the proposed target and a positive number indicates a user exceeding in overall attribute achievement for the proposed target.

19. The method of claim 18, wherein the combining of each difference with the retrieved importance data for the associated one or more retrieved attributes and computing the single value overall user assessment score that represents the overall assessment of compliance further comprises multiplying each of the differences between the response levels and the standard levels by the retrieved importance data associated with each of the retrieved queries, wherein the method further comprises the steps of:
computing the sum of all products;
dividing by the sum of all retrieved importance data values; and
normalizing the single value overall user assessment score.

20. The method claim 16, wherein the database is a first database, the method further providing an attribute and training presentation and further comprising the steps of:
further providing the assessment and improvement tool to further comprising:
an improvement programs database comprising one or more improvement programs associated with attributes comprised by the first database; and
an output list generator operation;
inputting by the query presenter the one or more response levels into the output list generator;
retrieving by the output list generator from the first database one or more standard levels associated with the attributes associated with the presented queries;
retrieving by the output list generator from the improvement programs database one or more improvement programs associated with the attributes associated with the presented queries; and
presenting to the user a list from the output list generator, wherein:
the list comprises at least one element for at least one of the attributes associated with the presented queries and the at least element is at least one of the retrieved one or more improvement programs associated with the at least one of the attributes associated with the presented queries; and
the list is usable by the user to identify at least one improvement program usable to improve attribute achievement levels associated with the at least one of the attributes associated with the presented queries.

21. The method claim 20, further providing an alternative target presentation and further comprising the steps of:
further providing the assessment and improvement tool to further comprising an alternative target generator operation;
inputting by the query presenter the one or more response levels into the alternative target generator;
retrieving by the alternative target generator from the first database attribute standard levels for at least a subset of functional regimes comprising and in addition to the user input functional regime, wherein the functional regimes in the at least a subset of functional regimes comprise attributes associated with the presented queries;
identifying by the alternative target generator alternative targets within the at least a subset of functional regimes where the response levels and the corresponding standard levels of the alternative targets indicate a smaller achieved attribute deficiency than the corresponding standard level for the proposed target input by the user, or indicate a meeting or exceeding of the required achieved attribute level of the identified alternative target; and
presenting by the alternative target generator to the user the identified alternative targets.

22. The method claim 16, further providing an alternative target presentation and further comprising the steps of:
further providing the assessment and improvement tool to further comprising an alternative target generator operation;
inputting by the query presenter the one or more response levels into the alternative target generator;
retrieving by the alternative target generator from the database attribute standard levels for at least a subset of functional regimes comprising and in addition to the user input functional regime, wherein the functional regimes in the at least a subset of functional regimes comprise attributes associated with the presented queries;
identifying by the alternative target generator alternative targets within the at least a subset of functional regimes where the response levels and the corresponding standard levels of the alternative targets indicate a smaller achieved attribute deficiency than the corresponding standard level for the proposed target input by the user, or indicate a meeting or exceeding of the required achieved attribute level of the identified alternative target; and
presenting by the alternative target generator to the user the identified alternative targets.

23. A method of assisting a user (i.e., a person or entity) in achieving a new position, status, certification, or identifiable goal, the method providing an attribute and training presentation comprising the steps of:
providing an assessment and improvement tool comprising:
a first database comprising functional regimes, targets, attributes, queries, graded responses, attribute standards, and standard levels, wherein:
a target is a new position, status, certifications, or identifiable goal;
a functional regime has one or more associated targets;
a target has one or more associated attributes;
an attribute has associated:
attribute standards comprising one or more standard levels which represent required achievement levels related to the attribute; and
one or more queries comprising one or more graded responses, wherein:
a user input received in response to a query related to the attribute is a response level comprised by the one or more graded responses and represents a user achievement level related to the attribute; and
a difference between the response level and a corresponding standard level of the attribute standards associated with the attribute assesses a deficiency, meeting or exceeding in the user achieved level when assessed against a required level of achievement associated with the attribute;
an improvement programs database comprising one or more improvement programs associated with attributes comprised by the first database;
a functional regime selector operation;
an attributes generator operation;
a query generator operation;
a query presenter operation; and
an output list generator operation;
accepting by the functional regime selector from a user a user input of a functional regime and a proposed target, wherein the functional regime selector inputs the proposed target into the attribute generator;
retrieving by the attribute generator from the first database one or more attributes associated with the proposed target, wherein the attribute generator inputs the one or more retrieved attributes into the query generator;
retrieving by the query generator from the first database one or more queries which comprise one or more graded responses and are associated with the attributes, wherein the query generator inputs at least one of the one or more retrieved queries into the query presenter;
presenting by the query presenter to the user the at least one of the one or more retrieved queries (thereby also referable to as presented queries);
receiving by the query presenter from the user one or more user inputs in response to the presented queries which are one or more response levels associated with the one or more graded responses associated with the presented queries, wherein the query presenter inputs the one or more response levels into the output list generator;
retrieving by the output list generator from the first database one or more standard levels associated with the attributes associated with the presented queries;
retrieving by the output list generator from the improvement programs database one or more improvement programs associated with the attributes associated with the presented queries; and
presenting to the user a list from the output list generator, wherein:
the list comprises at least one element for at least one of the attributes associated with the presented queries and the at least element is at least one of the retrieved one or more improvement programs associated with the at least one of the attributes associated with the presented queries; and
the list is usable by the user to identify at least one improvement program usable to improve attribute achievement levels associated with the at least one of the attributes associated with the presented queries.

24. The method of claim 23, wherein the improvement programs of the improvement programs database are linked to one or more queries of the first database and the retrieved improvement programs are linked to the presented queries and associated with the attributes associated with the presented queries.

25. The method of claim 23, wherein the improvement programs of the improvement programs database are improvement programs from subscriber organizations.

26. The method of claim 23, wherein:
the list comprises at least two types of elements for each of the one or more retrieved attributes, wherein one type is an improvement program type and a second type is a response level type or a standard level type.

27. The method of claim 23, wherein:
the list comprises at least three types of elements for each of the attributes associated with the presented queries;
the at least three types comprise an improvement program type, a response level type and a standard level type; and
the list is usable by the user to evaluate their attribute achievement levels relative to the required attribute achievement levels required for the attributes associated with the presented queries, and identify improvement programs usable to improve attribute achievement levels.

28. The method of claim 27, wherein the response level type and the standard level type for each attribute are normalized.

29. The method of claim 27, wherein the improvement program type are training programs related to attributes associated with the target input by the user.

30. The method claim 23, further providing an alternative target presentation and further comprising the steps of:
further providing the assessment and improvement tool to further comprising an alternative target generator operation;
inputting by the query presenter the one or more response levels into the alternative target generator;
retrieving by the alternative target generator from the first database attribute standard levels for at least a subset of functional regimes comprising and in addition to the user input functional regime, wherein the functional regimes in the at least a subset of functional regimes comprise attributes associated with the presented queries;
identifying by the alternative target generator alternative targets within the at least a subset of functional regimes where the response levels and the corresponding standard levels of the alternative targets indicate a smaller achieved attribute deficiency than the corresponding standard level for the proposed target input by the user, or indicate a meeting or exceeding of the required achieved attribute level of the identified alternative target; and
presenting by the alternative target generator to the user the identified alternative targets.

31. A method of assisting a user (i.e., a person or entity) in achieving a new position, status, certification, or identifiable goal, the method providing an alternative target presentation comprising the steps of:
providing an assessment and improvement tool comprising:
a database comprising functional regimes, targets, attributes, queries, graded responses, attribute standards, and standard levels, wherein:
a target is a new position, status, certifications, or identifiable goal;
a functional regime has one or more associated targets;
a target has one or more associated attributes;
an attribute has associated:
attribute standards comprising one or more standard levels which represent required achievement levels related to the attribute; and
one or more queries comprising one or more graded responses, wherein:
a user input received in response to a query related to the attribute is a response level comprised by the one or more graded responses and represents a user achievement level related to the attribute; and
a difference between the response level and a corresponding standard level of the attribute standards associated with the attribute assesses a deficiency, meeting or exceeding in the user achieved level when assessed against a required level of achievement associated with the attribute;
a functional regime selector operation;
an attributes generator operation;
a query generator operation;
a query presenter operation; and
an alternative target generator operation;
accepting by the functional regime selector from a user a user input of a functional regime and a proposed target, wherein the functional regime selector inputs the proposed target into the attribute generator;
retrieving by the attribute generator from the database one or more attributes associated with the proposed target, wherein the attribute generator inputs the one or more retrieved attributes into the query generator;
retrieving by the query generator from the database one or more queries which comprise one or more graded responses and are associated with the attributes, wherein the query generator inputs at least one of the one or more retrieved queries into the query presenter;
presenting by the query presenter to the user the at least of the one or more retrieved queries (thereby also referable to as presented queries);
receiving by the query presenter from the user one or more user inputs in response to the presented queries which are one or more response levels associated with the one or more graded responses associated with the presented queries, wherein the query presenter inputs the one or more response levels into the alternative target generator;
retrieving by the alternative target generator from the database attribute standard levels for at least a subset of functional regimes comprising and in addition to the user input functional regime, wherein the functional regimes in the at least a subset of functional regimes comprise attributes associated with the presented queries;
identifying by the alternative target generator alternative targets within the at least a subset of functional regimes where the response levels and the corresponding standard levels of the alternative targets indicate a smaller achieved attribute deficiency than the corresponding standard level for the proposed target input by the user, or indicate a meeting or exceeding of the required achieved attribute level of the identified alternative target; and
presenting by the alternative target generator to the user the identified alternative targets.

32. The method of claim 30, wherein the at least a subset of functional regimes only includes functional regimes specified by the user.

33. The method of claim 30, wherein the at least a subset of functional regimes includes all functional regimes comprising at least one attribute in common with the proposed target input by the user.
